(19) United States
(12) Patent Application Publication
(10) Pub. No.: US 2012/0192683 A1
(43) Pub. Date: Aug. 2, 2012

(54) HAND TOOL WITH A BUSHING

(76) Inventor: Yi-Fu Chen, Taichung City (TW)

(21) Appl. No.: 13/015,583

(22) Filed: Jan. 28, 2011

(51) Int. Cl. B25B 13/46; B25B 23/00

(52) U.S. Cl. 81/62; 81/60; 81/63.1

(57) ABSTRACT

A hand tool with a bushing includes a receiving space defined in a driving head thereof, a ratchet assembly movably received in the receiving space for adapting to driving a work piece, and a bushing disposed between the ratchet assembly and an inner periphery of the receiving space. The ratchet assembly has an outer configuration substantially corresponding in geometry to the receiving space. When the ratchet assembly is operated, the bushing is able to sustain a wear of the ratchet assembly.

### BACKGROUND OF THE INVENTION

1. Field of the Invention

The present invention relates to a hand tool with a bushing, and more particularly to a hand tool having a ratchet assembly mounted therein and enclosed by a bushing for preventing wearing of the ratchet assembly.

2. Description of Related Art

A conventional ratchet wrench has a ratchet disposed on a head thereof and mounted with a work piece for operating. An engaging member is selectively engaged with the ratchet for limiting a rotating direction of the ratchet. A switch is movably mounted in the head. A pressing member is mounted in the switch and is located adjacent to the engaging member for abutting against the engaging member. When the switch is turned to a lateral side of the head, the pressing member is moved to abut against the engaging member. The engaging member is moved to abut against an inner periphery of the head and engage with the ratchet for allowing the ratchet to move in a corresponding rotating direction. Therefore, the ratchet is able to change the rotating direction by shifting the switch.

However, the prior art suffers from several disadvantages. Due to the abutting force between the engaging member and the inner periphery of the head, the engaging member would rub against the inner periphery of the head. The ratchet may be idling during engaging with the engaging member, such that the ratchet or the engaging member would rub against the inner periphery of the head. Accordingly, a gap which defines between the inner periphery of the head and the outer peripheries of the ratchet, the engaging member, and the switch may increase. Therefore, the connection of the components is easily loosened and the ratchet would move in an undesired rotating direction.

The present invention has arisen to mitigate and/or obviate the disadvantages of the conventional ratchet wrench.

### SUMMARY OF THE INVENTION

The main objective of the present invention is to provide an improved hand tool with a bushing

To achieve the objective, a hand tool with a bushing in accordance with the present invention is a ratchet wrench and comprises a receiving space defined in a driving head thereof The receiving space is divided into a first space, a second space, and a third space. The second space is located between the first space and the third space for communicating with the first and third space.

A ratchet assembly is movably received in the receiving space for adapting to driving a work piece. The ratchet assembly has an outer configuration substantially corresponding in geometry to the receiving space. The ratchet assembly comprises a ratchet head movably received in the first space, a directional positioner movably received in the second space, and a switch member movably received in the third space. The directional positioner has a toothed portion formed on a top thereof for selectively engaged with the ratchet head. An abutting member is movably mounted in the switch member. The abutting member selectively and adjustably abuts against a bottom of the directional positioner opposite to the toothed portion by shifting the switch member;

A bushing is disposed between the ratchet assembly and an inner periphery of the receiving space. The bushing has an outer periphery substantially corresponding to the inner periphery of the receiving space and encloses the outer configuration of the ratchet assembly. The bushing and the driving head of the hand tool are made of different metal materials. The bushing has a hardness greater than that of the inner periphery of the receiving space of the driving head.

Therefore, when the ratchet assembly is operated, the bushing is able to sustain a wear of the ratchet assembly. A rotating direction of the ratchet head is controllable by changing an engagement of the toothed portion of the directional positioner.

In accordance with another aspect of the present invention, the receiving space is divided into a first space and a second space communicating with the first space. The driving head has two recesses defined in an inner periphery of the second space. The bushing has two curved portions formed in a bottom thereof for being correspondingly and respectively received in the two recesses. The ratchet assembly comprises a ratchet head movably received in the first space and two directional positioners movably receiving in the second space. Each directional positioner has a pivot portion formed on a bottom thereof and pivotally mounted in the corresponding curved portion for abutting against the bushing. Each directional positioner has a toothed portion formed on a top thereof for selectively engaged with the ratchet head.

A switch member is movably received in the second space and located between the two directional positioners. The switch member has a flat portion and a protruding portion oppositely formed in an outer periphery thereof for respectively and laterally abutting against the two directional positioners. Two elastomers are compressibly received in the second space. Each elastomer is disposed between the corresponding directional positioner and the inner periphery of the bushing for providing a resilient force.

When the protruding portion of the switch member is shifted to abut against one directional positioner, the directional positioner is pivotally moved to compress the corresponding elastomer and disengages from the ratchet head. The other directional positioner is pivotally moved to abut against the flat portion by the resilient force of the corresponding elastomor and engage with the ratchet head, such that a rotating direction of the ratchet head is controllable.

In accordance with another aspect of the present invention, the receiving space is divided into a first space and a second space communicating with the first space. The ratchet assembly comprises a ratchet head movably received in the first space and a directional positioner movably received in the second space. The directional positioner has a toothed portion formed on a top thereof for selectively engaged with the ratchet head. The directional positioner has a first abutting surface for abutting against an inner periphery of the bushing and a second abutting surface which is located opposite to the first abutting surface. An elastomer is compressibly received in the second space. The elastomer has two ends respectively abutting against the second abutting surface of the directional positioner and the inner periphery of the bushing for providing a resilient force.

When the directional positioner is driven to compress the elastomer, the ratchet head is rotatable. When the directional positioner abuts against the inner periphery of the bushing, the ratchet head is engagingly restricted with the toothed portion.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a preferred embodiment of a hand tool with a bushing in accordance with the present invention;

FIG. 2 is an assembled perspective view of the preferred embodiment of the hand tool with a bushing in accordance with the present invention;

FIG. 3 is a partial cross-sectional view of the preferred embodiment of the hand tool with a bushing in accordance with the present invention;

FIG. 4 is a partial cross-sectional view of a second embodiment of the hand tool with a bushing in accordance with the present invention;

FIG. 5 is a perspective view of the second embodiment of a bushing of the hand tool with a bushing in accordance with the present invention;

FIG. 6 is a partial cross-sectional view of a third embodiment of the hand tool with a bushing in accordance with the present invention; and

FIG. 7 is a perspective view of the third embodiment of a bushing of the hand tool with a bushing in accordance with the present invention.

### DETAILED DESCRIPTION OF THE INVENTION

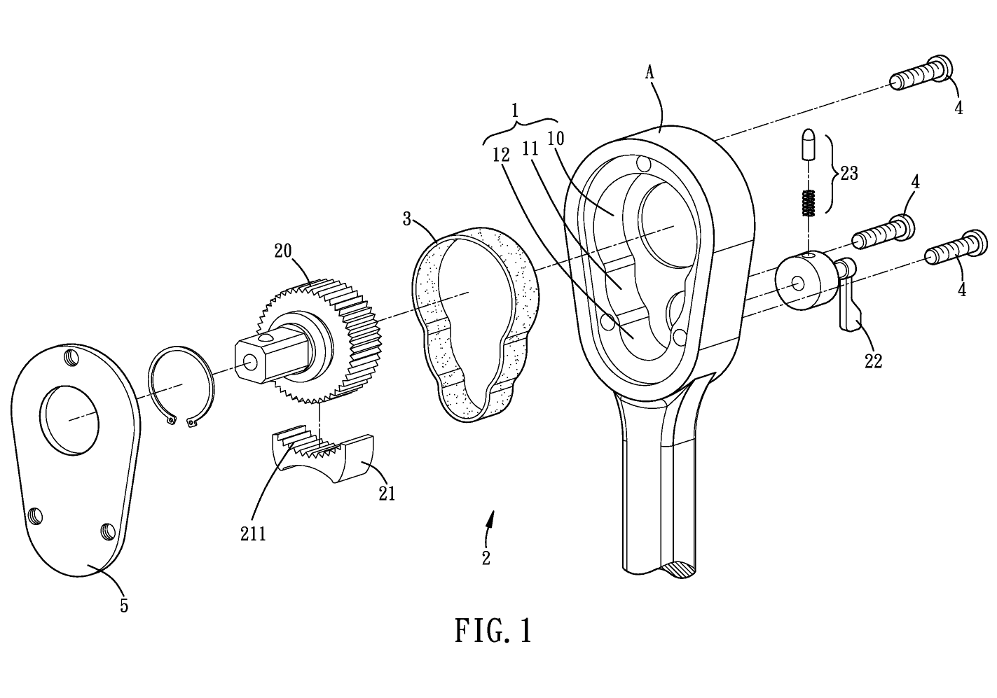

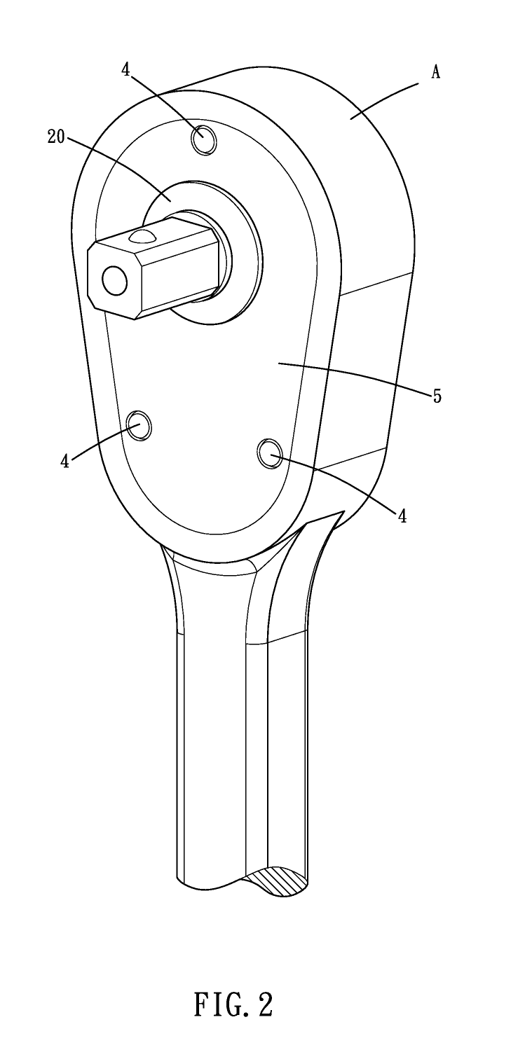

Referring to the drawings and initially to FIGS. 1-3, a hand tool with a bushing in accordance with a preferred embodiment of the present invention is a ratchet wrench and comprises a receiving space 1 defined in a driving head A of the ratchet wrench (not numbered). The receiving space 1 is divided into a first space 10, a second space 11, and a third space 12. The second space 11 is located between the first space 10 and the third space 12 for communicating with the first space 10 and the third space 12.

A ratchet assembly 2 is movably received in the receiving space 1 for driving a work piece (not shown). The ratchet assembly 2 has an outer configuration substantially corresponding in geometry to the receiving space 1. The ratchet assembly 2 comprises a ratchet head 20 movably received in the first space 10, a directional positioner 21 movably received in the second space 11, and a switch member 22 movably received in the third space 12. The ratchet head 20 has a plurality of teeth (not numbered) formed on an outer periphery thereof. The directional positioner 21 has a toothed portion 211 formed on a top thereof for selectively engaged with the teeth of the ratchet head 20. An abutting member 23 is movably mounted in the switch member 22. The abutting member 23 includes a pusher (not numbered) and a spring (not numbered) which is located underneath the pusher, such that the spring tends to push the pusher to abut against a bottom of the directional positioner 21 which is opposite to the toothed portion 211. The switch member 22 is pivotally rotatable to adjust an abutting position of the abutting member 23.

A bushing 3 is disposed between the ratchet assembly 2 and an inner periphery of the receiving space 1. The bushing 3 has an outer periphery substantially corresponding to the inner periphery of the receiving space 1 and encloses the outer configuration of the ratchet assembly 2. The bushing 3 is able to sustain a wear of the ratchet assembly 2. The bushing 3 and the driving head A of the hand tool are made of different metal materials. The bushing 3 has a hardness greater than that of the inner periphery of the receiving space 1 of the driving head A. A cover 5 securely covers the receiving space 1 and fastens to the driving head A via a plurality of screws 4 for positioning the ratchet assembly 2 and the bushing 3 in the receiving space 1.

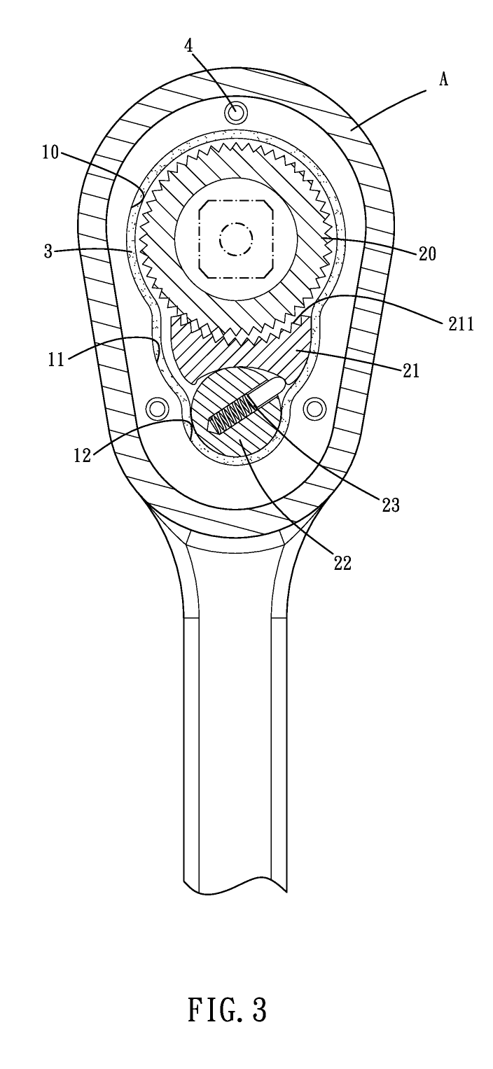

The operation of the hand tool with bushing in accordance with the present invention will be described in detailed below. As shown in FIG. 3, the abutting member 23 is moved to abut against the bottom of the directional positioner 21 by pivotally rotating the switch member 22. A rotating direction of the ratchet head 20 is controllable by changing an engagement of the toothed portion 211 of the directional positioner 21.

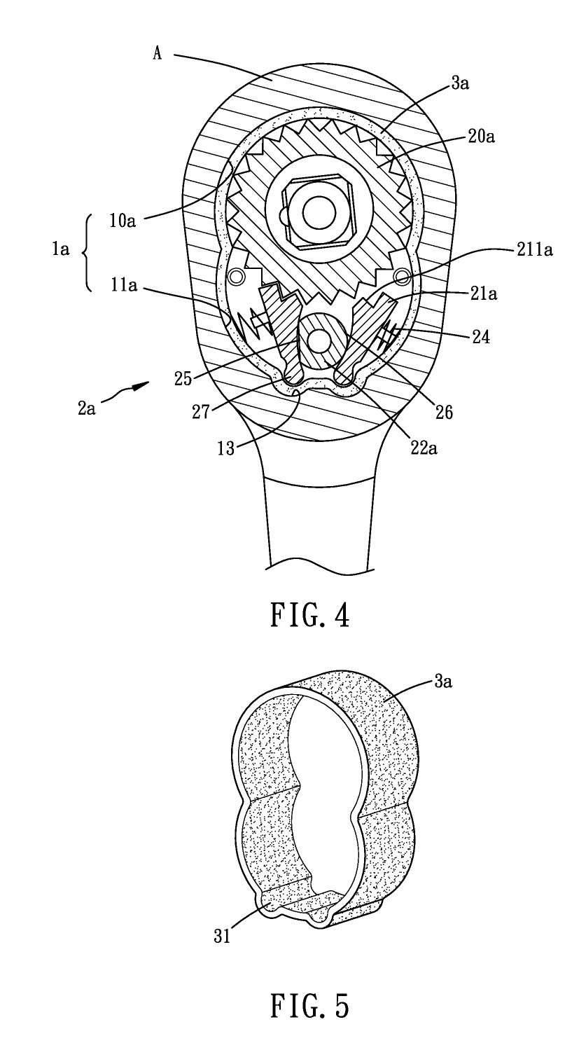

FIGS. 4-5 show a second embodiment of the hand tool with a bushing according to the present invention. The elements and effects of the second embodiment which are the same with the preferred embodiment are not described, only the differences are described. The receiving space 1a is divided into a first space 10a and a second space 11a communicating with the first space 10a. The driving head A has two recesses 13 defined in an inner periphery of the second space 11a. The bushing 3a has two curved portions 31 formed in a bottom thereof for being correspondingly and respectively received in the two recesses 13. The bushing 3a has an outer periphery substantially corresponding to the inner periphery of the receiving space 1a and encloses the outer configuration of the ratchet assembly 2a. The ratchet assembly 2a comprises a ratchet head 20a movably received in the first space 10a and two directional positioners 21a pivotally receiving in the second space 11a. Each directional positioner 21a has a pivot portion 27 formed on a bottom thereof and mounted in the corresponding curved portion 31 for abutting against the bushing 3a, such that the two directional positioners 21a are pivotally and respectively rotatable about the two pivot portions 27. Each directional positioner 21a has a toothed portion 211a formed on a top thereof for selectively engaged with the teeth of the ratchet head 20a.

A switch member 22a is movably received in the second space 11a and located between the two directional positioners 21a. The switch member 22a has a flat portion 25 and a protruding portion 26 oppositely formed in an outer periphery thereof for respectively and laterally abutting against the two directional positioners 21a. Two elastomers 24 are compressibly received in the second space 11a. Each elastomer 24 is disposed between the corresponding directional positioner 21a and the inner periphery of the bushing 3a for providing a resilient force.

When the protruding portion 26 abuts against one directional positioner 21a by pivotally rotating the switch member 22a, the directional positioner 21a is pivotally moved to compress the corresponding elastomer 24 and disengages from the ratchet head 20a. The other directional positioner 21 a is pivotally moved to abut against the flat portion 25 by the resilient force of the corresponding elastomor 24 and engage with the ratchet head 20a, such that a rotating direction of the ratchet head 20a is controllable.

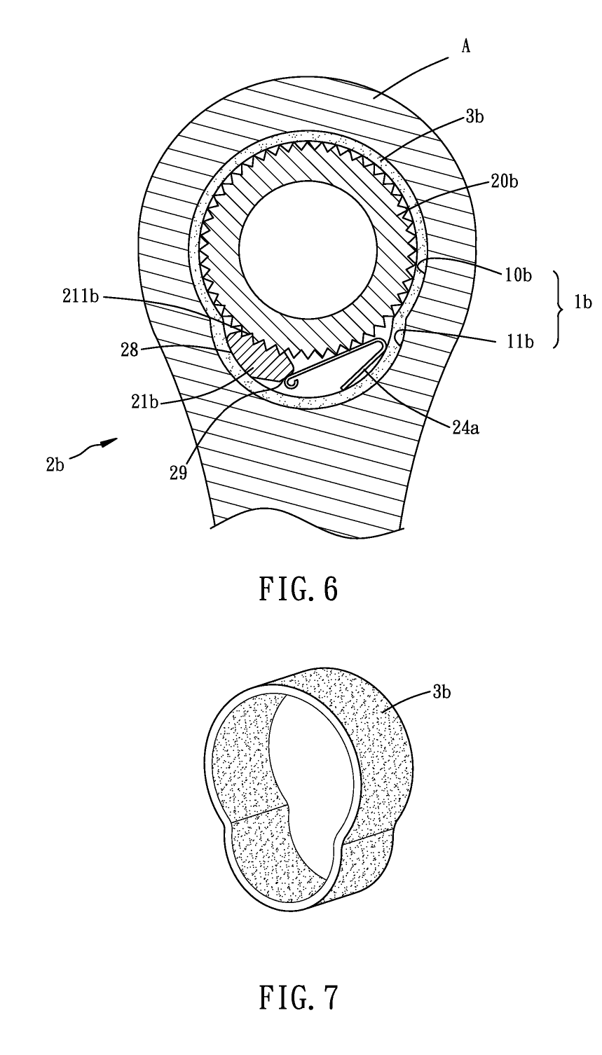

FIGS. 6-7 show a third embodiment of the hand tool with a bushing according to the present invention. The elements and effects of the third embodiment which are the same with the preferred embodiment are not described, only the differences are described. The receiving space lb is divided into a first space 10b and a second space 11b communicating with the first space 10b. The bushing 3b has an outer periphery substantially corresponding to the inner periphery of the receiving space 1b and encloses the outer configuration of the ratchet assembly 2b. The ratchet assembly 2b comprises a ratchet head 20b movably received in the first space 10b and a directional positioner 21b movably received in the second space 11b. The directional positioner 21b has a toothed portion 211b formed on a top thereof for selectively engaged with the teeth of the ratchet head 20b. The directional positioner 21b has a first abutting surface 28 for abutting against an inner periphery of the bushing 3b and a second abutting surface 29 which is located opposite to the first abutting surface 28. An elastomer 24a is compressibly received in the second space 11b. The elastomer 24a has two ends respectively abutting against the second abutting surface 29 of the directional positioner 21b and the inner periphery of the bushing 3b for providing a resilient force.

When the directional positioner 21b is driven to compress the elastomer 24a, the ratchet head 20b is rotatable. When the directional positioner 21b abuts against the inner periphery of the bushing 3b, the ratchet head 20b is engagingly restricted with the toothed portion 211b.

Although the invention has been explained in relation to its preferred embodiment, it is to be understood that many other possible modifications and variations can be made without departing from the spirit and scope of the invention as hereinafter claimed.

What is claimed is:

1. A hand tool with a bushing comprising:
a receiving space defined in a driving head thereof;
a ratchet assembly movably received in the receiving space for adapting to driving a work piece, the ratchet assembly having an outer configuration substantially corresponding in geometry to the receiving space; and
a bushing disposed between the ratchet assembly and an inner periphery of the receiving space;
wherein when the ratchet assembly is operated, the bushing is able to sustain a wear of the ratchet assembly.

2. The hand tool with a bushing as claimed in claim 1, wherein the bushing has an outer periphery substantially corresponding to the inner periphery of the receiving space and encloses the outer configuration of the ratchet assembly, the bushing and the driving head of the hand tool made of different metal materials.

3. The hand tool with a protective bushing as claimed in claim 1, wherein the bushing has a hardness greater than that of the inner periphery of the receiving space of the driving head.

4. The hand tool with a bushing as claimed in claim 1, wherein the hand tool is a ratchet wrench, the receiving space divided into a first space, a second space, and a third space, the second space located between the first space and the third space for communicating with the first and third space, the ratchet assembly comprising:
a ratchet head movably received in the first space;
a directional positioner movably received in the second space, the directional positioner having a toothed portion formed on a top thereof for selectively engaged with the ratchet head;
a switch member movably received in the third space; and
an abutting member movably mounted in the switch member, the abutting member selectively and adjustably abutting against a bottom of the directional positioner opposite to the toothed portion by shifting the switch member;
wherein a rotating direction of the ratchet head is controllable by changing an engagement of the toothed portion of the directional positioner.

5. The hand tool with a bushing as claimed in claim 1, wherein the hand tool is a ratchet wrench, the receiving space divided into a first space and a second space communicating with the first space, the ratchet assembly comprising:
a ratchet head movably received in the first space;
two directional positioners movably received in the second space, each directional positioner having a pivot portion formed on a bottom thereof and abutting against an inner periphery of the bushing, each directional positioner having a toothed portion formed on a top thereof for selectively engaged with the ratchet head;
a switch member movably received in the second space and located between the two directional positioners, the switch member having a flat portion and a protruding portion oppositely formed in an outer periphery thereof for respectively and laterally abutting against the two directional positioners; and
two elastomers compressibly received in the second space, each elastomer disposed between the corresponding directional positioner and the inner periphery of the bushing for providing a resilient force;
wherein when the protruding portion of the switch member is shifted to abut against one directional positioner, the directional positioner is pivotally moved to compress the corresponding elastomer and disengages from the ratchet head, the other directional positioner pivotally moved to abut against the flat portion by the resilient force of the corresponding elastomor and engaging with the ratchet head, such that a rotating direction of the ratchet head is controllable.

6. The hand tool with a bushing as claimed in claim 5, wherein the driving head has two recesses defined in an inner periphery of the second space, the bushing having two curved portions formed in a bottom thereof for being correspondingly and respectively received in the two recesses, the pivot portion of each directional positioner pivotally mounted in the corresponding curved portion.

7. The hand tool with a bushing as claimed in claim 1, wherein the hand tool is a ratchet wrench, the receiving space divided into a first space and a second space communicating with the first space, the ratchet assembly comprising:
a ratchet head movably received in the first space;
a directional positioner movably receiving in the second space, the directional positioner having a toothed portion formed on a top thereof for selectively engaged with the ratchet head, the directional positioner having a first abutting surface for abutting against an inner periphery of the bushing and a second abutting surface located opposite to the first abutting surface; and
an elastomer compressibly received in the second space, the elastomer having two ends respectively abutting against the second abutting surface of the directional positioner and the inner periphery of the bushing for providing a resilient force;
wherein when the directional positioner is driven to compress the elastomer, the ratchet head is rotatable; when the directional positioner abuts against the inner periphery of the bushing, the ratchet head is engagingly restricted with the toothed portion.
